(19) United States
(12) Patent Application Publication
(10) Pub. No.: US 2014/0293322 A1
(43) Pub. Date: Oct. 2, 2014

(54) PRINTING ELECTRONIC MESSAGES

(71) Applicant: HEWLETT-PACKARD DEVELOPMENT COMPANY, LP., Houston, TX (US)

(72) Inventor: Goyal Anurag, Bangalore (IN)

(73) Assignee: Hewlett-Packard Development Company, LP., Houston, TX (US)

(21) Appl. No.: 13/853,156

(22) Filed: Mar. 29, 2013

(51) Int. Cl. G06F 3/12

(52) U.S. Cl. CPC G06F 3/1296
USPC 358/1.15

(57) ABSTRACT

Systems and methods for printing electronic messages are described herein. In one implementation, the e-message printing system determines at least one message parameter of an e-message and ascertains whether a user defined template is associated with the e-message, based on the at least one message parameter. The e-message printing system further selects, based on the ascertaining, at least one of the associated user defined template and a standard template for printing the e-message. Then, the e-message printing system generates a print job, for execution by a web enabled printer, for printing the e-message based on the selection.

### BACKGROUND

Electronic message (e-message), such as electronic mail (e-mail), has become a popular form of communication for both business and personal purposes. Many e-message service providers provide e-message accounts to a user which may be accessed using a browser. Further, there are many commercially available e-message clients which facilitate the user to download e-messages from the e-message service providers for offline viewing. The e-message clients may also provide additional functionalities, such as composing new message and searching the downloaded messages. In many situations the user may wish to print an e-message.

Typically, for printing the e-message, the user selects a print command of the e-message client, or the browser, or the e-message service provider. The page settings, of the e-message being printed, may vary based on the browser or the e-message client or the service provider. For example, on receiving the print command, certain e-message clients may print a current e-message, whereas other e-message clients may print the current e-message as well as all trailing e-messages. In another example, certain e-message service providers may automatically print the documents, in certain file formats, provided as attachments to the e-message on the user invoking the print command. For other e-message service providers the user may have to open each document attached to the e-message, using an appropriate application and print the document using the print command of the application.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the figures to reference like features and components:

FIG. 1a schematically illustrates an electronic message printing system, according to an example of the present subject matter.

FIG. 1b schematically illustrates a network environment including the electronic message printing system, according to another example of the present subject matter.

FIG. 1c schematically illustrates the network environment including the electronic message printing system and a print control system, according to another example of the present subject matter.

FIG. 2a illustrates a method for printing an e-message, according to an example of the present subject matter.

FIG. 2b illustrates a method for printing an e-message, according to another example of the present subject matter.

FIG. 3 illustrates a computer readable medium storing instructions for printing an e-message, according to an example of the present subject matter.

### DETAILED DESCRIPTION

The present subject matter relates to systems and methods for printing electronic messages. The methods and the systems as described herein may be implemented using various commercially available computing systems and printers.

Most users usually have multiple e-message accounts, such as e-mail accounts, which may be used for various purposes. For example, a first e-message account may be used for business transactions, a second e-message may be used for personal communication, and a third e-message account may be used for social networking. Based on the context of e-messages received on the same e-message account or different e-message accounts, the user may wish to print different portions of the e-messages. For example, for certain e-messages the user may wish to print the subject and the body of the e-message. In another example, for an electronic ticket which has been sent over e-message, the user may want to print the body of the e-message and may not want the subject or other fields to be printed.

In many cases the user may have to print the e-messages using the default settings of the browser or the e-message client or the e-message service provider. This may lead to the user printing portions of the e-messages he may not need resulting in wastage of paper and toner of a printer. In many situations where the user wishes to print attachments, the user may have to open each document, attached to the e-message, using an appropriate application and print the document using the print command of the application. This makes printing of attachments tedious and time-consuming.

The systems and the methods, described herein, implement printing of electronic messages. In one example, the method of printing electronic messages is implemented using an e-message printing system and a web enabled printer. The e-message printing system may be implemented by any computing device, such as personal computers, network servers, and servers. The web enabled printer may be an inkjet printer, a laser printer, a large format printer, and a multi function printer (MFP).

For initial setup, the user may use a user console of the web enabled printer to set his e-message account on the e-message printing system. For example, the user console may prompt the user to enter various message setup details for accessing the e-message accounts of the user. The message setup details may also be saved for future use. In one example, the user may classify his e-message accounts into various e-message categories using various e-message labels, such as personal messages, official messages, and group messages.

The user may also define various templates for printing e-messages. In another example, the user may select and customize various templates stored in the e-message printing system for printing e-messages. The user may also associate templates with e-messages that are received from particular senders or particular domains. The e-message printing system may then use the associated templates for printing all e-messages received from the particular senders or the particular domains. These templates may be referred as the user defined templates or the templates.

In operation, the user may use the user console of the web enabled printer to access his e-message account. Based on the user input, the message setup details of the user's e-message account may be retrieved and e-messages from the user's e-message account may be fetched for being displayed to the user. The user may then be prompted to select an e-message for printing.

On receiving a user input, indicative of the user's selection, the e-message printing system may ascertain whether there is a user defined template associated with the selected e-message based on the sender of the e-message or the domain from which the e-message has been sent. In one example, on ascertaining an associated template as existing, the e-message printing system may generate a print job and transmit the same to the web enabled printer for execution. In another example, the e-message printing system may request the user to confirm whether to proceed with printing of the selected e-message using the associated template. The e-message printing system may also facilitate the user to select a different template for printing the e-message.

In another example, on ascertaining an associated template as not existing, the e-message printing system may prompt the user to select a template, from amongst the standard templates stored in the e-message printing system, for printing the selected e-message. The e-message printing system may also prompt the user to confirm whether to print all future e-messages from the same sender or the same domain, as that of the selected e-message, using the selected template.

Thus, the systems and the methods, described herein, facilitate the user to print e-messages from multiple e-message accounts of multiple e-message service providers using templates. Printing of e-messages using user defined templates facilitate the users to print the desired portions of emessage and thus save toner as well as paper. The above described systems and methods also facilitate the user to print e-messages without using a separate computing device.

The above systems and the methods are further described in conjunction with the following figures. It should be noted that the description and figures merely illustrate the principles of the present subject matter. Further, various arrangements may be devised that, although not explicitly described or shown herein, embody the principles of the present subject matter and are included within its spirit and scope.

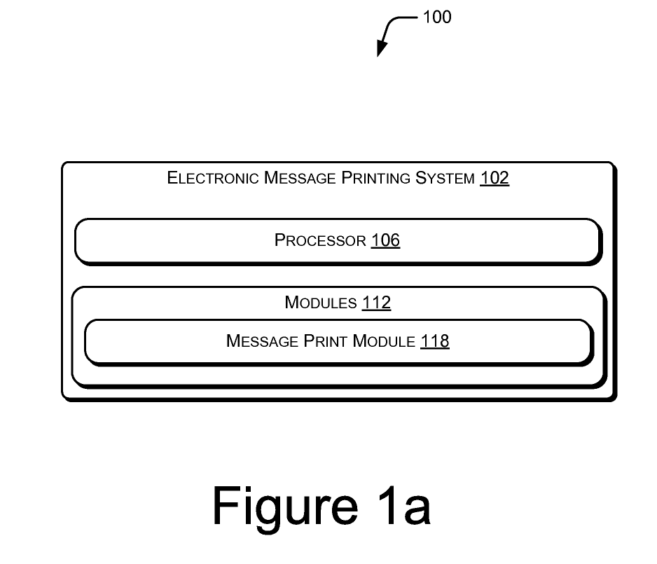

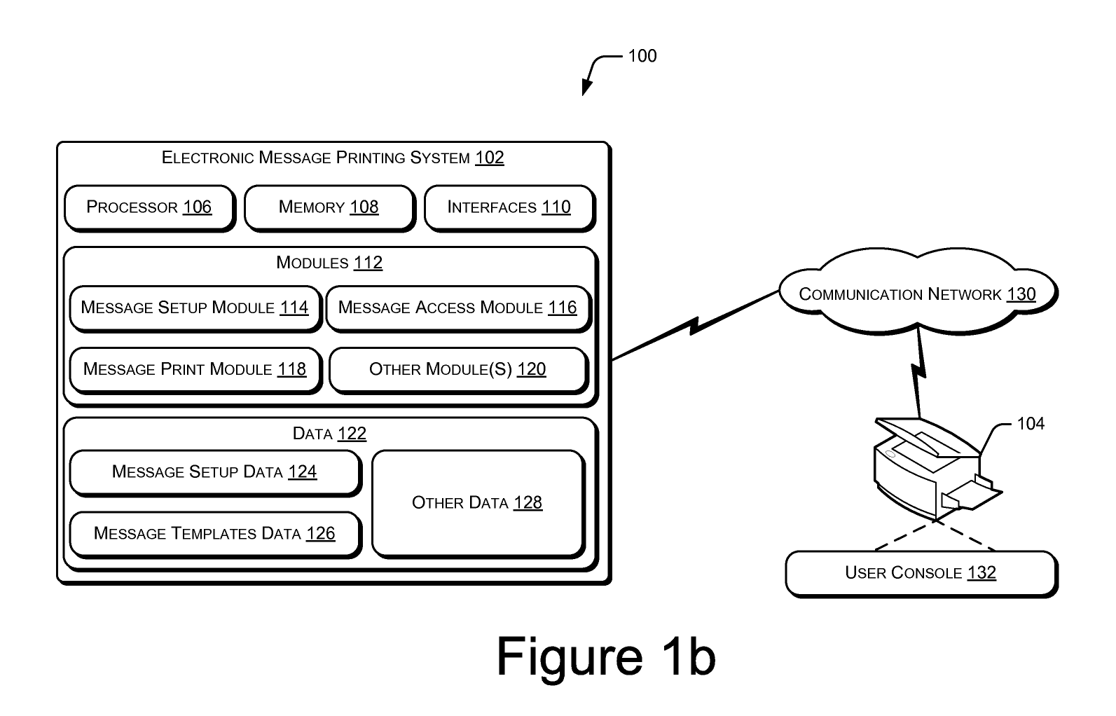

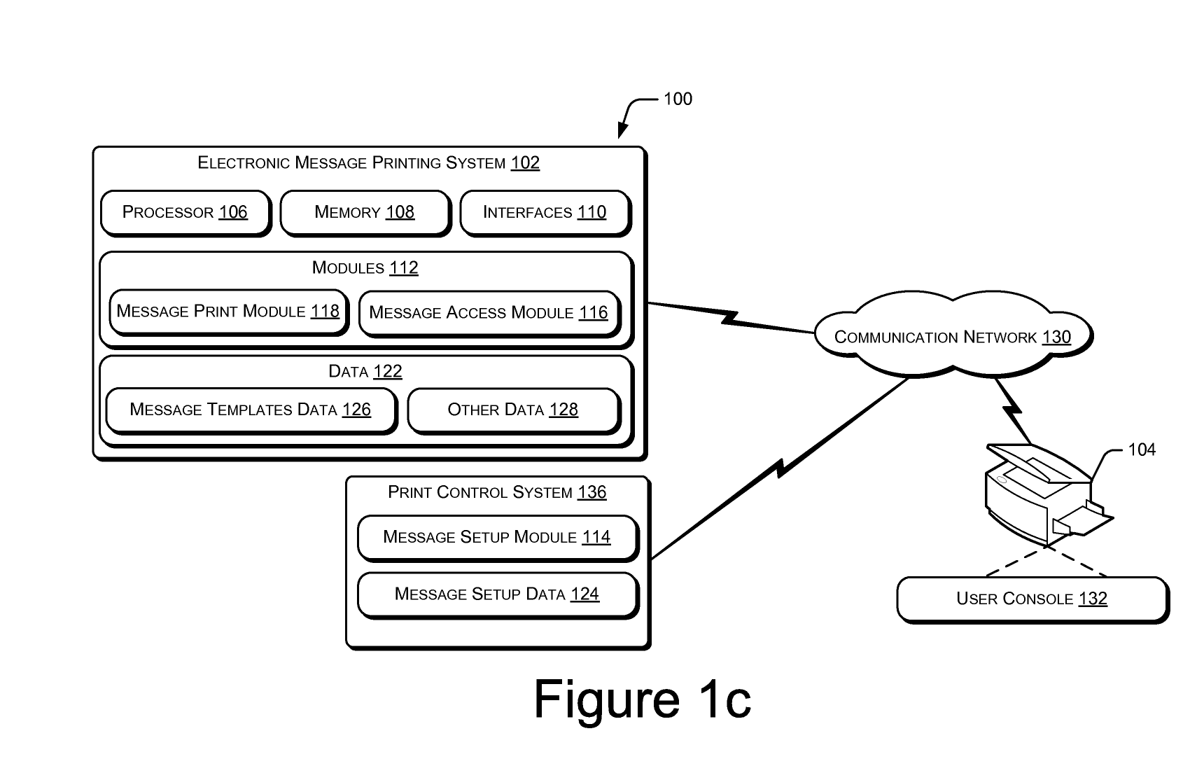

The manner in which the systems and methods for print e-messages are implemented are explained in details with respect to FIGS. 1a, 1b, 1c, 2a, 2b, and 3. While aspects of described systems and methods for print e-messages can be implemented in any number of different computing systems, environments, and/or implementations, the examples and implementations are described in the context of the following system(s).

FIG. 1a schematically illustrates the components of an e-message printing system 102, according to an example of the present subject matter. In one example, the e-message printing system 102 may be implemented as any commercially available printer.

In one implementation, the e-message printing system 102 includes a processor 106 and modules 112 communicatively coupled to the processor 106. The modules 112, amongst other things, include routines, programs, objects, components, and data structures, which perform particular tasks or implement particular abstract data types. The modules 112 may also be implemented as, signal processor(s), state machine(s), logic circuitries, and/or any other device or component that manipulate signals based on operational instructions. Further, the modules 112 can be implemented by a hardware, by computer-readable instructions executed by a processing unit, or by a combination thereof. In one implementation, the modules 112 include a message print module 118.

In one example, the message print module 118 determines at least one message parameter of an e-message. The message print module 118 may further ascertain whether a user defined template is associated with the e-message, based on the at least one message parameter. Based on the ascertaining, the message print module 118 selects at least one of the associated user defined template and a standard template for printing the e-message. Then, the message print module 118 generates a print job, for execution by a web enabled printer, for printing the e-message based on the selection. The operation of the e-message printing system 102 is described in detail in conjunction with FIGS. 1b and 1c.

FIG. 1b schematically illustrates a network environment 100 including the e-message printing system 102 and a web enabled printer 104, according to another example of the present subject matter. The web enabled printer 104 may be implemented as a variety of printers, such as a large format printer, an inkjet printer, a laser printer, and a multi function printer. In one example, the web enabled printer 104 may include the e-message printing system 102.

In one implementation, the e-message printing system 102 includes the processor 106, and a memory 108 connected to the processor 106. Among other capabilities, the processor 106 may fetch and execute computer-readable instructions stored in the memory 108.

The memory 108 may be communicatively coupled to the processor 106. The memory 108 can include any commercially available non-transitory computer-readable medium including, for example, volatile memory, and/or non-volatile memory.

Further, the e-message printing system 102 includes various interfaces 110. The interfaces 110 may include a variety of commercially available interfaces, for example, interfaces for peripheral device(s), such as data input and output devices, referred to as I/O devices, storage devices, and network devices. The interfaces 110 facilitate the communication of the e-message printing system 102 with various communication and computing devices and various communication networks, such as networks that use a variety of protocols, for example, Hypertext Transfer Protocol (HTTP) and Transmission Control Protocol/Internet Protocol (TCP/IP).

Further, the e-message printing system 102 may include the modules 112. In said implementation, the modules 112 include a message setup module 114, a message access module 116, the message print module 118, and other module(s) 120. The other module(s) 120 may include programs or coded instructions that supplement applications or functions performed by the e-message printing system 102.

In an example, the e-message printing system 102 includes data 122. In said implementation, the data 122 may include a message setup data 124, message templates data 126, and other data 128. The other data 128 may include data generated and saved by the modules 112 for providing various functionalities of the e-message printing system 102.

In one implementation, the e-message printing system 102 may be communicatively coupled to the web enabled printer 104 over a communication network 130. The communication network 130 may include Global System for Mobile Communication (GSM) network, Universal Mobile Telecommunications System (UMTS) network, or any communication networks that use any of the commonly used protocols, for example, Hypertext Transfer Protocol (HTTP) and Transmission Control Protocol/Internet Protocol (TCP/IP).

In one example, the web-enabled printer 104 includes a user console 132. The user console 132 may be implemented as a touch-screen or as a display and a keypad. The user console 132 provides the user an interface to interact with the web-enabled printer 104.

For the initial set up, the user may use the user console 132 to access the message setup module 114 to setup his e-message accounts on the e-message printing system 102. In one example, the user may provide various message setup parameters, such as his username, his password, the internet protocol (IP) address of the incoming message server of his e-message account, the port of the incoming message server, and whether a secure connection needs to be established, for accessing the user's e-messages. The message setup module 114 may save the message setup parameters as the message setup data 124 for future use. The user may also categorize the e-message accounts into various e-message categories using e-message labels, such as personal messages, official messages, and group messages.

The user may further use the user console 132 to access the message setup module 114 and customize various user-defined templates for printing e-messages. In one example, the e-message printing system 102 may include various standard templates, for printing of e-messages, as message templates data 126. The templates may be pre-developed page layouts in electronic format, containing various fields. The fields may then be customized with various data extracted from the e-messages. For example, a first template may include a single field which may be filled with data extracted from the body of the e-messages, a second template may include multiple fields which may be filled with data extracted from the subject followed by data extracted from the body of the e-message, and a third template may include fields that may be filled with content extracted from the attachments of the e-message.

In said example, the message setup module 114 may retrieve various standard templates from the message templates data 126 and prompt the user to select and customize a template for printing e-messages. The user may also associate different templates with e-messages based on message parameters, such as sender's e-message address, sender's domain name, subject of the e-message and e-message label. The message setup module 114 may store the association of the templates with e-messages based on message parameters as the message setup data 124.

In operation, the user console 132 of the web enabled printer 104 may generate a user interface for the user to access his e-message accounts. The user may then provide an input indicative of the e-message account which he wants to check. Based on the user input, the message setup module 114 may retrieve the message setup parameters associated with the selected e-message account from the message setup data 124. The message access module 116 may then access the e-message account of the user and download the user's e-messages. In one example, the message access module 116 may use various protocols, such as Internet message access protocol (IMAP) and Post Office Protocol version 3(POP3) to retrieve e-messages of the user. The message access module 116 may then transmit a list of retrieved e-messages to the user console 132 for being displayed to the user.

The user may then select the e-message to be printed using the user interface generated by the user console 132. On receiving the user input to print the selected e-message, the message print module 118 may determine the message parameters of the selected e-message and ascertain if there is an associated user defined template with the e-message.

In situations, where an associated user defined template exists, the message print module 118 may generate a print job and transmit the same to the web enabled printer 104 for execution. In another example, the message print module 118 may generate a prompt requesting to confirm proceeding with printing of the selected e-message using the associated template. In said example, the user may use the message print module 118 to print the selected e-message using a different user defined template.

In situations where an associated user defined template does not exist, the message print module 118 may retrieve various standard templates from the message templates data 126 and prompt the user to select a template for printing the selected e-message. On receiving a user input, indicative of the user's selection, the message print module 118 may generate a print job and transmit the same to the web enabled printer 104 for execution. The message print module 118 may also facilitate the user to confirm whether to print all future e-messages having the same message parameters, as of the selected e-message, should be printed using the selected standard template.

In another example, the message print module 118 may also facilitate the user to define print page settings for printing the e-message. The page settings, for printing the e-message may determine whether any header or footer is to be printed, whether background image is to be printed, whether the e-message is to be printed on a grayscale, whether the e-message is to be printed in duplex, and so on. The page settings may also define the margins for each page. The message print module 118 may further facilitate the user to associate the page settings with e-messages based on message parameters such that all future e-messages having the same message parameters, as of the selected e-message, are printed using the same page settings.

FIG. 1c schematically illustrates a network environment 100 including the e-message printing system 102, the web enabled printer 104 and a print control system 136 according to another example of the present subject matter. In one implementation, the print control system 136 may be implemented as various commercially available computing systems, such as workstations, desktops, and servers.

In one example, the e-message printing system 102 includes the message access module 116, the message print module 118, and the message templates data 126. In said example, the print control system 136 includes a processor (not shown in figure) and a memory (not shown in figure) communicatively coupled to the processor. The print control system 136 further includes the message setup module 114 and message setup data 124. In one implementation, the print control system 136 may also function as electronic print center for the web enabled printer 104 and may facilitate the user to view status of the web enabled printer 104, add and remove applications on the web enabled printer and manage settings and job history of the web enabled printer 104.

For the initial set up of the user's e-message account, the user may access the message setup module 114 of the print control system 136 to setup his e-message accounts on the print control system 136. The message setup module 114 may save the message setup parameters as the message setup data 124, in the print control system 136, for future use.

The user may further use the message setup module 114 to customize various templates for printing e-messages. In one example, the user may select and customize a template, stored in the message templates data 124, for printing e-messages. The user may also associate different templates with e-messages based on message parameters. The message setup module 114 may store the association of the templates with e-messages, based on message parameters, as the message setup data 124.

In operation, the user uses the user interface generated by the user console 132 to access his e-message accounts. The user may then select the e-message account which he wants to check. Based on the user input, the message setup module 114 may retrieve the message setup parameters associated with the selected e-message account from the message setup data 124 and transmit the same to the message access module 116 over the communication network 130. The message access module 116 may then access the e-message account of the user and download the user's e-messages. The message access module 116 may generate a list of retrieved messages and transmit the same to the user console 132 for being displayed to the user.

The user may then select the e-message to be printed. On receiving the user input to print the selected e-message, the message print module 118 may determine the message parameters of the selected e-message and ascertain if there is an associated template with the e-message.

In situations where an associated template exists, the message print module 118 may generate a print job and transmit the same to the web enabled printer 104 for execution. In situations where an associated template does not exist, the message print module 118 may retrieve various templates from the message templates data 124 and prompt the user to select a template for printing the selected e-message. On receiving the user's selection, the message print module 118 may generate a print job and transmit the same to the web enabled printer 104 for execution.

Thus, the e-message printing system 102 facilitates the user to print desired portions of e-messages from multiple e-message accounts of multiple e-message service providers using templates and thus save toner as well as paper. Further, the user does not have to use any additional computing system or e-message capable client, such as a smartphone and a personal digital assistant, to transmit the e-message to the web enabled printer 104.

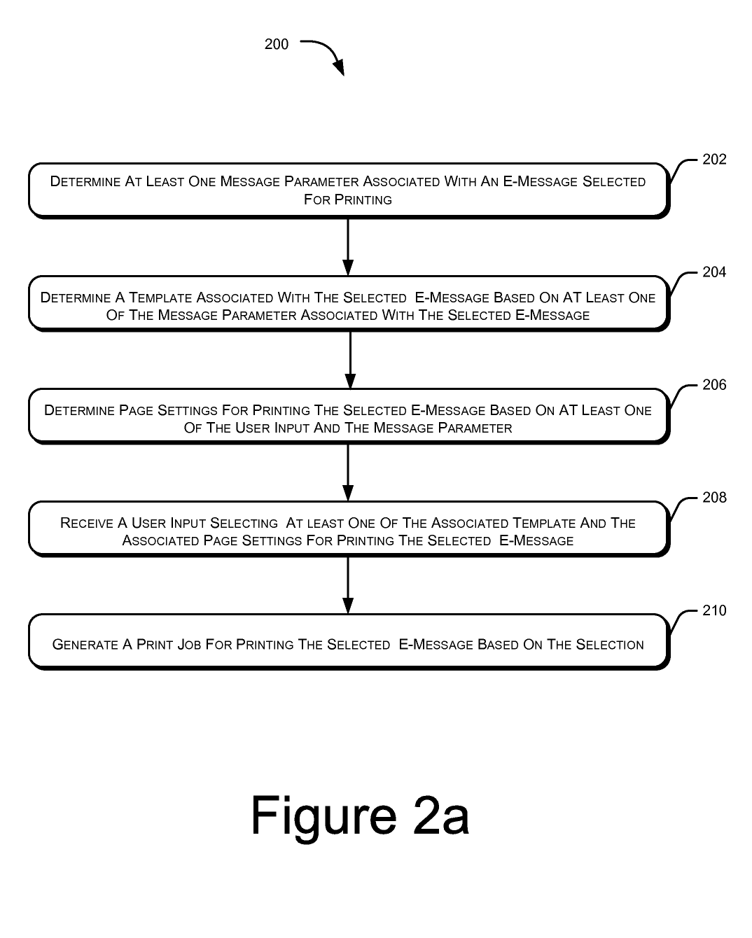

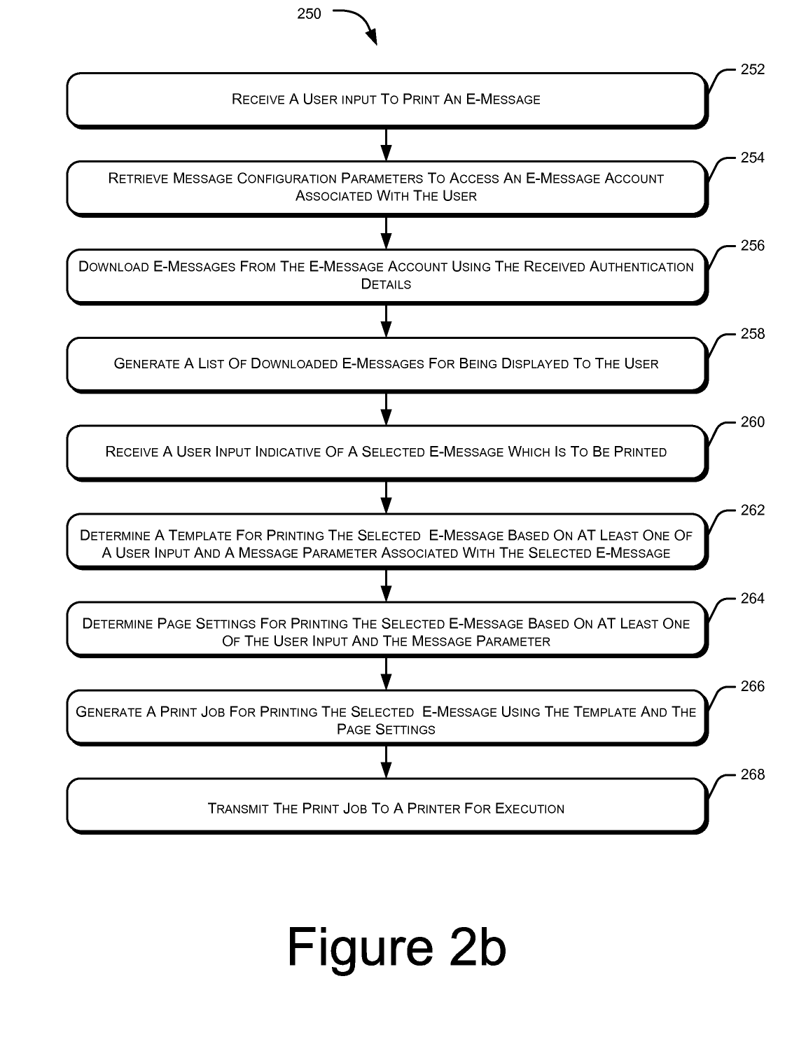

FIGS. 2a and 2b illustrate methods 200 and 250 for printing electronic messages, according to an example of the present subject matter. The order in which the methods 200 and 250 are described is not intended to be construed as a limitation, and any number of the described method blocks can be combined in any order to implement the methods 200 and 250, or an alternative method. Additionally, individual blocks may be deleted from the method 200 without departing from the spirit and scope of the subject matter described herein. Furthermore, the methods 200 and 250 may be implemented in any suitable hardware, computer-readable instructions, or combination thereof.

The steps of the methods 200 and 250 may be performed by either a computing device under the instruction of machine executable instructions stored on a storage media or by a dedicated hardware circuits, microcontrollers, or logic circuits. Herein, some examples are also intended to cover program storage devices, for example, digital data storage media, which are machine or computer readable and encode machine-executable or computer-executable programs of instructions, where said instructions perform some or all of the steps of the described methods 200 and 250. The program storage devices may be, for example, digital memories, magnetic storage media, such as a magnetic disks and magnetic tapes, hard drives, or optically readable digital data storage media.

With reference to method 200 as depicted in FIG. 2a, as depicted in block 202, at least one message parameter, associated with an e-message selected for printing, is determined.

As illustrated in block 204, a template, which is associated with the selected e-message, is determined based on at least one of the message parameter associated with the selected e-message.

As shown in block 206, page settings are determined, for printing the selected e-message, based on at least one of the user input and the message parameter

At block 208, a user input, indicative of the user's selection of at least one of the associated template and the associated page settings, for printing the selected e-message is received.

As depicted in block 210, a print job is generated, for printing the selected e-message, based on the selection.

With reference to method 250 as depicted in FIG. 2b, as depicted in block 252, a user input to print an e-message is received. In one example, the user may use the user interface generated by the user console 132 to provide the user input to print an e-message.

As illustrated in block 254, message setup parameters to access an e-message account associated with the user are retrieved. In one example, the message access module 116 may retrieve message setup parameters, such as the authentication details of the e-message account of the user to access the user's e-message account.

As shown at block 256, the e-messages are downloaded from the e-message account using the received authentication details. In one implementation, the message access module 116 may retrieve or download e-messages from the user's e-message account using various protocols, such as IMAP and POP3.

As depicted in block 258, a list of downloaded e-messages is generated for being displayed to the user. In one implementation, the message access module 116 may transmit the list of downloaded e-messages to the user console 132 for being displayed to the user. The list may include various details, such as the sender's address, the subject of the downloaded e-messages, and a preview of the content of the downloaded e-messages.

As shown in block 260, a user input, indicative of a selected e-message which is to be printed, is received. In one example, the user may use the user interface generated by the user console 132 to select the e-message to be printed from amongst the downloaded e-messages.

At block 262, a template for printing the selected e-message based on at least one of a user input and an e-message account parameter associated with the e-message account is determined. In one implementation, the message print module 118 may analyze the selected e-message to ascertain various message parameters, such as the sender's e-message address, and the sender's domain. Based on the ascertained message parameters, the message print module 118 may determine whether there is an associated template for printing the e-message or not. In another implementation, the message print module 118 may prompt the user to select a template for printing the selected e-message.

As illustrated in block 264, the page settings for printing the selected e-message are determined based on at least one of the user input and the e-message account parameter associated with the e-message account. In one example, the message print module 118 may determine whether there are page settings associated for printing the selected e-message based on message parameters. In another example, the message print module 118 may prompt the user to select page settings for printing the selected e-message.

As depicted in block 266, a print job for printing the e-message using the template and the page settings is generated. In one example, the message print module 118 may generate the print job in a printer job language (PJL). The print job may include commands in a printer job language, such as printer command language (PCL), based on the model of the web enabled printer 104, for the web enabled printer 104 to process the print job.

As shown in block 268, the print job is transmitted to a printer for execution. In one example, the message print module 118 may transmit the print job to the web enabled printer 104, over the communication network 130, for execution.

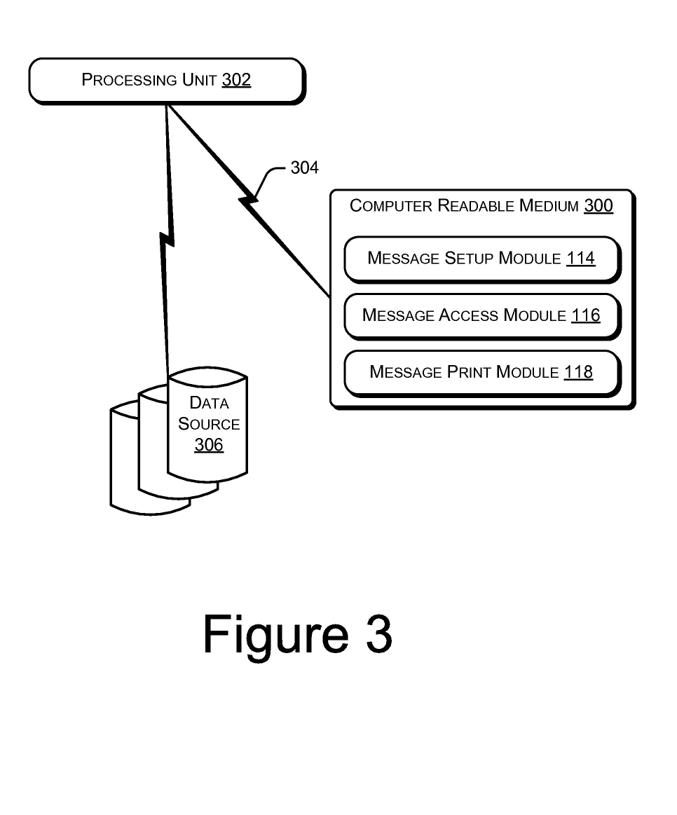

FIG. 3 illustrates a computer readable medium 300 storing instructions for printing an e-message, according to an example of the present subject matter. In one example, the computer readable medium 300 is communicatively coupled to a processing unit 302 over communication link 304.

For example, the processing unit 302 can be a computing device, such as a server, a laptop, a desktop, a mobile device, and the like. The computer readable medium 300 can be, for example, an internal memory device or an external memory device or any commercially available non transitory computer readable medium. In one implementation, the communication link 304 may be a direct communication link, such as any memory read/write interface. In another implementation, the communication link 304 may be an indirect communication link, such as a network interface. In such a case, the processing unit 302 can access the computer readable medium 300 through a network.

The processing unit 302 and the computer readable medium 300 may also be communicatively coupled to data sources 306 over the network. The data sources 306 can include, for example, databases and computing devices. The data sources 306 may be used by the requesters and the agents to communicate with the processing unit 302.

In one implementation, the computer readable medium 300 includes a set of computer readable instructions, such as the message setup module 114, the message access module 116, and the message print module 118. The set of computer readable instructions can be accessed by the processing unit 302 through the communication link 304 and subsequently executed to perform acts for printing of electronic messages.

On execution by the processing unit 302, the message setup module 114 receives message setup parameters of an e-message account of a user. Based on the message setup parameters, the message access module 116, on execution, accesses the e-message account using the message setup parameters. The message access module 116 retrieves e-messages from the e-message account and generates a list of retrieved e-messages for being displayed to the user.

On receiving an user input indicative of selecting an e-message for printing, the message print module 118 determines at least one message parameter of an e-message selected for printing from the list of retrieved e-messages. The message print module 118 further ascertains whether at least one of a page setting and a template is associated with the selected e-message, based on the at least one message parameter. The message print module 118 also prompts the user to provide a user input to select at least one of the associated template and a different template for printing the e-message. The user input may also be indicative of the user selecting at least one of the associated page setting and a different page setting for printing the e-message. The message print module 118 then generates a print job for printing the selected e-message using the selected template and the selected page setting.

Although implementations for printing electronic messages have been described in language specific to structural features and/or methods, it is to be understood that the appended claims are not necessarily limited to the specific features or methods described. Rather, the specific features and methods are disclosed as examples of systems and methods for printing electronic messages.

I/We claim:

1. An electronic message (e-message) printing system comprising:
a processor; and
a message print module, coupled to the processor, to:
determine at least one message parameter of an e-message;
ascertain whether a user defined template is associated with the e-message, based on the at least one message parameter;
selecting, based on the ascertaining, at least one of the associated user defined template and a standard template for printing the e-message; and
generate a print job, for execution by a web enabled printer, for printing the e-message based on the selection.

2. The e-message printing system as claimed in claim 1 further comprising:
a message setup module, coupled to the processor, to receive message setup parameters of an e-message account of a user; and
a message access module, coupled to the processor, to:
access the e-message account using the message setup parameters;
retrieve e-messages from the e-message account; and
generate a list of retrieved e-messages for being displayed to the user.

3. The e-message printing system as claimed in claim 2, wherein the message setup module further:
analyzes the retrieved e-messages to determine the at least one message parameter for each of the retrieved e-messages; and
classifies the retrieved e-messages into at least one e-message category identified by an e-message label, based on the at least one message parameter.

4. The e-message printing system as claimed in claim 2, wherein the message setup module further associates at least one template with an e-message based on at least one message parameter, based on user input.

5. The e-message printing system as claimed in claim 2, wherein the message setup module further facilitates defining of a new template for printing e-messages.

6. The e-message printing system as claimed in claim 2, wherein the message setup module further associates at least one page setting with an e-message based on at least one message parameter, based on user input.

7. The e-message printing system as claimed in claim 1, wherein the message print module further:
ascertains whether a page setting is associated with the selected e-message, based on the at least one message parameter;
receives a user input selecting at least one of the associated page setting and a different page setting for printing the e-message; and
generates a print job, for execution by the web enabled printer, for printing the selected e-message using the selected page setting.

8. A method of printing electronic messages, the method comprising:
determining at least one message parameter of an e-message selected for printing;
ascertaining whether at least one of a page setting and at least one user defined template are associated with the selected e-message, based on the at least one message parameter;
selecting the at least one of the associated user defined template and a standard template for printing the e-message;
receiving a user input for selecting the at least one of the associated page setting and a different page setting for printing the e-message; and
generating a print job for printing the selected e-message using the selected template and the selected page setting.

9. The method as claimed in claim 8, the method further comprising:
receiving message setup parameters of an e-message account of a user;
accessing the e-message account using the message setup parameters;
retrieving e-messages from the e-message account; and
generating a list of retrieved e-messages for being displayed to the user.

10. The method as claimed in claim 9, the method further comprising:
analyzing the retrieved e-messages to determine the at least one message parameter for each of the retrieved e-messages; and
classifying the retrieved e-messages into at least one e-message category identified by an e-message label, based on the at least one message parameter.

11. The method as claimed in claim 8, the method further comprising associating at least one template with an e-message based on at least one message parameter, based on user input.

12. The method as claimed in claim 8, the method further comprising associating at least one page setting with an e-message based on at least one message parameter, based on user input.

13. A non-transitory computer-readable medium having a set of computer readable instructions that, when executed, cause an e-message printing system to:
receive message setup parameters of an e-message account of a user;
access the e-message account using the message setup parameters;
retrieve e-messages from the e-message account;
generate a list of retrieved e-messages for being displayed to the user;
determine at least one message parameter of an e-message selected for printing from the list of retrieved e-messages;
ascertain whether at least one of a page setting and a template is associated with the selected e-message, based on the at least one message parameter;
receive a user input selecting at least one of the associated template and a different template for printing the e-message;
receive a user input selecting at least one of the associated page setting and a different page setting for printing the e-message; and
generate a print job for printing the selected e-message using the selected template and the selected page setting.

14. The non-transitory computer-readable medium as claimed in claim 13, wherein the instructions executed further cause the e-message printing system to:
analyze the retrieved e-messages to determine the at least one message parameter for each of the retrieved e-messages; and
classify the retrieved e-messages into at least one e-message category identified by an e-message label, based on the at least one message parameter.
